(19) United States
(12) Patent Application Publication
(10) Pub. No.: US 2025/0257931 A1
(43) Pub. Date: Aug. 14, 2025

(54) REFRIGERATOR AND CONTROL METHOD THEREFOR

(71) Applicant: SAMSUNG ELECTRONICS CO., LTD., Suwon-si (KR)

(72) Inventors: Yoonhee CHOI, Suwon-si (KR); Seongjoo HAN, Suwon-si (KR); Harsh AGARWAL, Suwon-si (KR)

(73) Assignee: SAMSUNG ELECTRONICS CO., LTD., Suwon-si (KR)

(21) Appl. No.: 19/191,270

(22) Filed: Apr. 28, 2025

Related U.S. Application Data
(63) Continuation of application No. PCT/KR2023/016755, filed on Oct. 26, 2023.

(30) Foreign Application Priority Data
Dec. 6, 2022 (KR) 10-2022-0169094

(51) Int. Cl. F25D 23/02

(52) U.S. Cl. CPC F25D 23/028; F25D 2600/00

(57) ABSTRACT

A refrigerator and a control method therefor. The refrigerator includes a main body including a storage chamber, a door, a camera located in at least one of the body and the door to capture at least one of the storage chamber and the pantry, an output portion, a memory, and a processor that, based on introducing of an item to or withdrawing of the item from one of the storage chamber and the pantry is detected, controls the output portion to provide first feedback, obtains information about a storage location of the item that is detected, through the image captured by the camera, controls the output portion to provide second feedback including information about the storage location of the item, obtains information about the item that is detected, and controls the output portion to provide third feedback including the information about the item that is detected.

### CROSS-REFERENCE TO RELATED APPLICATION

This application is a continuation application is a continuation application, under 35 U.S.C. § 111(a), of international application No. PCT/KR2023/016755, filed Oct. 26, 2023, which claims priority under 35 U. S. C. § 119 to Korean Patent Application No. 10-2022-0169094, filed Dec. 6, 2022, the disclosures of which are incorporated herein by reference in their entireties.

### TECHNICAL FIELD

The disclosure relates to a refrigerator and a control method therefor and more particularly, to a refrigerator providing feedback when stocking up (introducing) or taking out (withdrawing) food to or from the refrigerator and a control method therefor.

### BACKGROUND ART

In general, a refrigerator is a home appliance that includes a storage chamber storing food and a cool air supply device which supplies cool air to the storage chamber to keep food fresh for a long time.

In particular, a recent refrigerator includes a camera in a main body including the storage chamber to photograph the inside of the main body. Further, the refrigerator obtains information about food stored in the refrigerator at present based on the captured image and provides the obtained information about the food to a user.

### DISCLOSURE

### Technical Solution

According to an embodiment of the disclosure, a refrigerator includes a main body including a storage chamber, a door coupleable to the main body so that while the door and the main body are coupled to each other the door is rotatable to open and close the storage chamber and including a pantry, a camera located in at least one of the main body or the door to capture an image at least one of the storage chamber or the pantry, an output portion, a memory to store at least one instruction, and a processor coupleable to the memory and configured to execute the at least one instruction to, based on introducing of an item to or withdrawing of the item from one of the storage chamber or the pantry being detected through the image captured by the camera, control the output portion to provide first feedback corresponding to the item being introduced or withdrawn, obtain information about a storage location of the item that is detected to be item being introduced or withdrawn through the image captured by the camera, control the output portion to provide second feedback including the information about the storage location of the item, obtain information about the item that is detected to be stocked up or taken out through the image captured by the camera, and control the output portion to provide third feedback including the information about the item that is detected to be introduced or withdrawn.

According to an embodiment of the disclosure, a method of controlling a refrigerator including a main body including a storage chamber, a door coupleable to the main body so that while the door and the main body are coupled to each other the door is rotatable to open and close the storage chamber and including a pantry, and a camera located in at least one of the main body or the door to capture an image at least one of the storage chamber or the pantry includes, based on introducing of an item to or withdrawing of the item from one of the storage chamber or the pantry being detected through the image captured by the camera, providing first feedback corresponding to the item being introduced or withdrawn, obtaining information about a storage location of the item that is detected to be introduced or withdrawn through the image captured by the camera, providing second feedback including the information about the storage location of the item, obtaining information about the item that is detected to be introduced or withdrawn through the image captured by the camera, and providing third feedback including the information about the item that is detected to be introduced or withdrawn.

According to an embodiment of the disclosure, in a computer readable recording medium storing a program for executing a method of controlling a refrigerator including a main body including a storage chamber, a door coupleable to the main body so that while the door and the main body are coupled to each other the door is rotatable to open and close the storage chamber and including a pantry, and a camera located in at least one of the main body or the door to capture an image at least one of the storage chamber or the pantry, the control method includes, based on introducing of an item to or withdrawing of the item from one of the storage chamber or the pantry being detected through the image captured by the camera, providing first feedback corresponding to the item being introduced or withdrawn, obtaining information about a storage location of the item that is detected to be introduced or withdrawn through the image captured by the camera, providing second feedback including the information about the storage location of the item, obtaining information about the food that is detected to be introduced or withdrawn through the image captured by the camera, and providing third feedback including the information about the item that is detected to be introduced or withdrawn.

### Description of Drawings

FIG. 1 is a block diagram illustrating a configuration of a refrigerator according to an embodiment;

FIG. 2A is a view illustrating a refrigerator when a door of the refrigerator is closed according to an embodiment;

FIG. 2B is a view illustrating a refrigerator when a door of the refrigerator is opened according to an embodiment;

FIGS. 3A, 3B, 3C to 3D are views illustrating a stocking up or taking out detection area included in a refrigerator according to an embodiment;

FIG. 4A is a flow chart illustrating a method providing feedback when food is stocked up to a refrigerator according to an embodiment;

FIG. 4B is a view illustrating information related to stocking up of food displayed on a display of a refrigerator according to an embodiment;

FIG. 4C is a view illustrating information related to stocking up of food displayed on a user terminal according to an embodiment;

FIG. 5 is a flow chart illustrating a method providing feedback when food is taken out from a refrigerator according to an embodiment;

FIG. 6 is a flow chart illustrating a method of obtaining a consumption pattern of a user according to stocking up or taking out of food to provide various services according to an embodiment; and

FIG. 7 is a flow chart illustrating a method of controlling a refrigerator providing various feedback according to stocking up or taking out of food according to an embodiment.

### MODE FOR INVENTION

Hereinafter, various embodiments of the disclosure are described. However, the various embodiments are not for limiting technologies of the disclosure to a specific embodiment but they should be interpreted to include modifications, equivalents, and/or alternatives of the embodiments of the disclosure.

In the disclosure, the expression such as “have,” “may have,” “include”, or “may include” denotes the existence of such a characteristic (e.g. a numerical value, a function, an operation, or a component such as a part), and the expression does not exclude the existence of an additional characteristic.

In the disclosure, the expression “A or B”, “at least one of A and/or B”, “one or more of A and/or B”, or the like may include all possible combinations of the listed items. For example, “A or B”, “at least one of A and B”, or “at least one of A or B” may refer to all of the following cases: (1) including at least one A, (2) including at least one B, or (3) including all of at least one A and at least one B.

In the disclosure, the expression “1st”, “2nd”, “first,” “second” or the like used in the disclosure may describe various elements regardless of any order and/or degree of importance, wherein such expressions are used only to distinguish one element from another element and are not intended to limit the elements. For example, a first user device and a second user device may designate user devices different from each other regardless of any order or degree of importance. For example, a first component may be referred to as a second component and similarly, the second component may be also referred to as the first component exchangeably without departing from the scope of the right of the disclosure.

In the disclosure, the term “module”, “unit”, or “part” is a term for designating a component performing at least one function or operation and this component may be implemented as hardware or software or may be implemented as a combination of hardware and software. Also, a plurality of “modules”, “units”, or “parts” may be integrated into at least one module or chip and be implemented as a processor, excluding a case that there is need to implement each of them as an individual specific hardware.

Meanwhile, the description that one element (e.g. a first element) is “(operatively or communicatively) coupled with/to” or “connected to” another element (e.g. a second element) should be interpreted such that the one element is directly coupled to the another element or the one element is coupled to the another element through the other element (e.g. a third element). In contrast, the description that one element (e.g. a first element) is “directly coupled” or “directly connected” to another element (e.g. a second element) may be interpreted to mean that the other element (e.g. a third element) is not present between the one element and the another element.

The expression “configured to (or set to)” used in the disclosure may be interchangeably used with other expressions, for example, “suitable for”, “having the capacity to”, “designed to”, “adapted to”, “made to”, or “capable of” depending on circumstances. The term “configured to (or set to)” may not necessarily mean “specifically designed to” in terms of hardware. Instead, under some circumstances, the expression “a device configured to” may mean that the device “is capable of” performing an operation together with another device or component. For example, the phrase “a processor configured to (set to) perform A, B, and C” may mean a dedicated processor for performing the corresponding operations (e.g. an embedded processor), or a generic-purpose processor that may perform the corresponding operations by executing one or more software programs stored in a memory device (e.g. a CPU or an application processor).

The terms used in the disclosure are merely used for describing a specific example and may not be intended to limit the scope of other embodiments. A singular expression may include a plural expression, unless obviously differently defined in the context. The terms used here including technical terms or scientific terms may have the same meanings as meanings generally understood by those skilled in the art described in the disclosure. The terms defined in a general dictionary among terms used in the disclosure may be interpreted as the same or similar meanings as or to meanings included in the context of the related art, and is not interpreted as ideal or excessively formal meanings unless obviously differently defined in the context. In some cases, despite the term defined in the disclosure, the term should not be interpreted to exclude examples of the disclosure.

Hereinafter, with reference to the drawings, the disclosure is described more specifically. Meanwhile, in case it is determined that in describing the disclosure, the detailed description of related known functions or configurations may unnecessarily confuse the gist of the disclosure, the detailed description thereof will be omitted. With respect to the description of the drawings, similar components may be designated by similar reference numerals.

Hereinafter, with reference to the drawings, the disclosure is described more specifically.

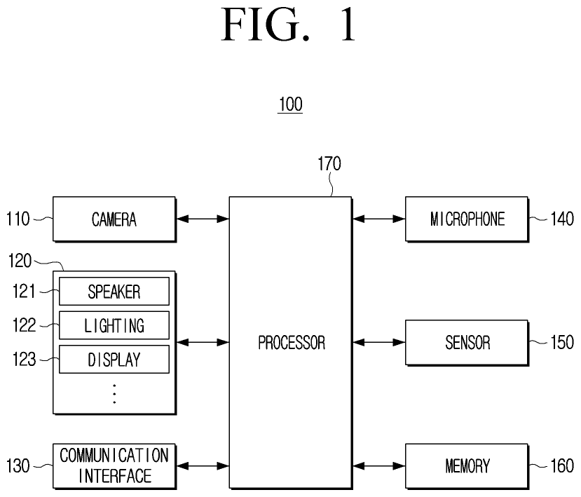

FIG. 1 is a block diagram illustrating a configuration of a refrigerator according to an embodiment. As shown in FIG. 1, a refrigerator 100 may include a camera 110, an output portion 120, a communication interface 130, a microphone 140, a sensor 150, memory 160, and a processor 170. The refrigerator 100 may be a device for storing food or medicine at a preset temperature to cool or not to decay the food or medicine. According to an embodiment, the refrigerator 100 is shown as a shape of a general home refrigerator but is not limited thereto and may be a Kimchi refrigerator, a liquor refrigerator, a cosmetics refrigerator, a freezer, etc.

The camera 110 is a component for photographing a subject to generate a photographed image, wherein the photographed image may include all of a moving image and a static image. In particular, the camera 110 may photograph areas of a storage chamber inside a main body 230 of the refrigerator 100 and a pantry of a door 210, 220. The camera 110 may be included in at least one area of an upper end area or a side area inside or outside the main body 230 for photographing a storage chamber inside the main body 230 and may be included in at least one area of an upper end area or a side area inside or outside the door 210, 220 for photographing a pantry of the door 210, 220. Also, the camera 110 may photograph an outside of the refrigerator 100. That is, the camera 110 may be implemented as not only one camera but also a plurality of cameras according to an embodiment.

Also, the camera 110 may photograph a stocking up or taking out detection area to provide the captured image to the processor 170.

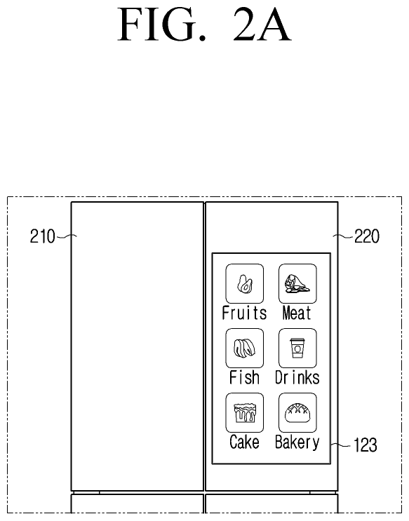

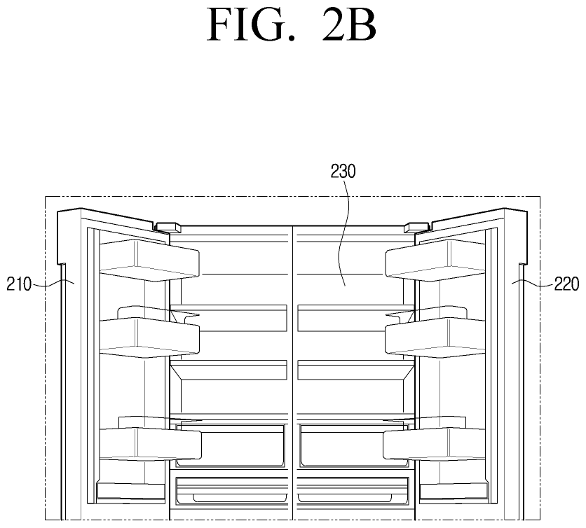

The output portion 120 may provide various feedback. In particular, as shown in FIG. 2, the output portion 120 may include a speaker 121, lighting 122, a display 123, or the like but it is merely an example, wherein another output portion (e.g. a haptic providing device, etc.) may be further included.

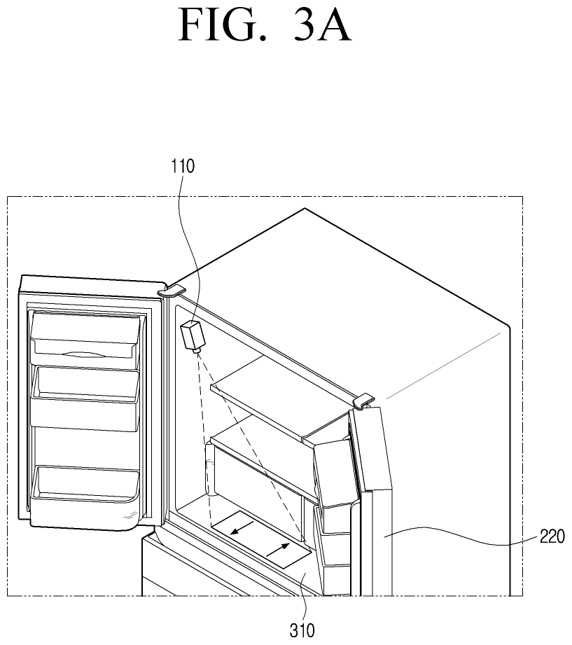

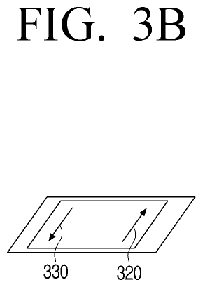

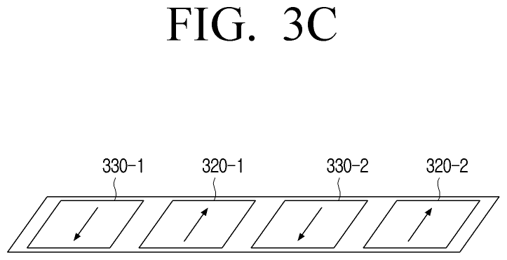

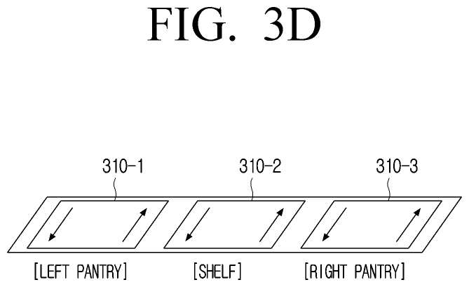

Here, the speaker 121 may be included inside or outside the refrigerator 100 and provide various auditory feedback through audio sound. The lighting 122 may be included in a storage chamber or a pantry inside the refrigerator 100 to provide various visual feedback through an indicator having a certain shape (e.g. an arrow), a flash, etc. Here, the lighting may be Light Emitting Diode (LED) but is not limited thereto. The lighting 122 may be referred to as LED 122 in embodiments. As shown in FIG. 3A, the display 123 is positioned in a partial area 220 among a plurality of doors 210, 220 to provide various visual feedback to a user.

In particular, the output portion 120 may provide feedback notifying that an area of food is detected, feedback corresponding to stocking up or taking out food, feedback including information about a storage location of food, or feedback including information about food detected to be stocked up or taken out in a visual form or an auditory form. With respect to the above, the description is specifically made hereafter.

The communication interface 130 may perform communication with an external server or an external terminal device. In particular, to obtain information about food, the communication interface 130 may transmit an image including food to the external server and receive information about food from the external server. Also, the communication interface 130 may transmit information about food and information about a storage location of food to a user terminal and receive a control command from the user terminal. Here, the communication interface 130 may directly perform communication with the user terminal but it is merely an example, wherein it is obvious that the communication interface 130 may perform communication with the user terminal outside through a server.

In particular, the communication interface 130 may perform communication with various external devices by using various wireless communication technologies or mobile communication technologies. This wireless communication technology may include, for example, Bluetooth, Bluetooth Low Energy, CAN communication, Wi-Fi, Wi-Fi Direct, ultrawide band (UWB), Zigbee, Infrared Data Association (IrDA), or Near Field Communication (NFC), and the mobile communication technology may include 3GPP, Wi-Max, Long Term Evolution (LTE), or 5G.

The microphone 140 may be a component which obtains and converts an audio signal to an electric signal and be included inside or outside the refrigerator 100. In particular, the microphone 140 may receive the audio signal including a user voice. Here, the user voice may include information about stocking up or taking out and information about food (e.g. a type of food, an expiration date of food).

The sensor 150 may detect an operation state (e.g. electric power or a temperature) of the refrigerator 100 or an external environment state (e.g. a user state) and may generate an electric signal or a data value corresponding to the detected state. In particular, the processor 170 may measure a temperature of each of a plurality of storage chambers of the refrigerator 100 based on a sensing value obtained through the sensor 150. Otherwise, the processor 170 may recognize that a user approaches through the sensor 150 and control the camera 110 to be ready.

The memory 160 may store an Operating System (OS) for controlling an overall operation of components of the refrigerator 100 and instructions or data related to the components of the refrigerator 100. In particular, the memory 160 may detect stocking up or taking out of food and store various configurations for providing various feedback.

Also, the memory 160 may store a database storing information about food stored in the refrigerator 100 (e.g. a type of food, a capacity of food, an expiration data of food, or a storage location of food).

Also, the memory 160 according to an embodiment may store a machine learning model (e.g. a neural network model for object recognition) for recognizing food that is stocked up or taken out to or from the refrigerator 100.

Meanwhile, the memory 160 may be implemented as non-volatile memory (e.g. a hard disk, a Solid State Drive (SSD), flash memory), volatile memory (capable of including memory inside at least one processor 170), etc.

The processor 170 may control the refrigerator 100 according to at least one instruction stored in memory 160.

In particular, the processor 170 may include one or more processors. Specifically, one or more processors may include one or more of a Central Processing Unit (CPU), a Graphics Processing Unit (GPU), an Accelerated Processing Unit (APU), a Many Integrated Core (MIC), a Digital Signal Processor (DSP), a Neural Processing Unit (NPU), a hardware accelerator, or a machine learning accelerator. The one or more processors may control one component or any combination of other components of the electronic device and perform an operation related to communication or data processing. The one or more processors may perform one or more programs or instructions stored in the memory. For example, the one or more processors may perform a method according to an embodiment of the disclosure by executing one or more instructions stored in the memory.

If a method according to an embodiment of the disclosure includes a plurality of operations, the plurality of operations may be performed by one processor and may be performed by a plurality of processors. That is, when a first operation, a second operation, and a third operation are performed by a method according to an embodiment, all of the first operation, the second operation, and the third operation may be performed by a first processor and also, the first operation and the second operation are performed by the first processor (e.g. a general purpose processor) and the third operation may be performed by a second processor (e.g. an Artificial Intelligence (AI)-dedicated processor). For example, an operation for providing feedback may be performed by the general purpose processor such as a CPU, and an operation for recognizing food for obtaining information about food may be performed by the AI-dedicated processor such as a NPU.

The one or more processors may be implemented as a single core processor including one core and may be implemented as one or more multi core processors including a plurality of cores (e.g. homogeneous multicores or heterogeneous multicores). If the one or more processors are implemented as a multi core processor, each of the plurality of cores included in the multi core processor may include processor internal memory such as cache memory and on-chip memory, wherein a common cache shared by the plurality of cores may be included in the multi core processor. Also, each of the plurality of cores included in the multi core processor (or part of the plurality of cores) may read and perform program instructions for independently implementing a method according to an embodiment of the disclosure and also, may read and perform program instructions for implementing a method according to an embodiment of the disclosure in connection with all (or part) of the plurality of cores.

If a method according to an embodiment of the disclosure includes a plurality of operations, the plurality of operations may be performed by one core among the plurality of cores included in the multi core processor and may be performed by the plurality of cores. For example, when a first operation, a second operation, and a third operation are performed by a method according to an embodiment, all of the first operation, the second operation, and the third operation may be performed by a first core included in the multi core processor and also, the first operation and the second operation may be performed by the first core included in the multi core processor and the third operation may be performed by the second core included in the multi core processor.

In embodiments of the disclosure, a processor may mean a System on Chip (SoC) onto which one or more processors and other electronic components are integrated, a single core processor, a multi core processor, or a core included in the single core processor or the multi core processor, wherein the core may be implemented as a CPU, a GPU, an APU, a MIC, a DSP, a NPU, a hardware accelerator, a machine learning accelerator, or the like but embodiments of the disclosure are not limited thereto.

In particular, if stocking up or taking out food to or from one of the storage chamber or the pantry is detected through an image captured by the camera 110, the processor 170 controls the output portion 120 to provide first feedback corresponding to the stocking up or the taking out. Further, the processor 170 obtains information about a storage location of food that is detected to be stocked up or taken out though the image captured by the camera 110. Still further, the processor 170 controls an output portion 120 to provide second feedback including the information about the storage location of the food. Further, the processor 170 obtains information about food that is detected to be stocked up or taken out though the image captured by the camera 110. Still further, the processor 170 controls an output portion 120 to provide third feedback including the information about the food that is detected to be stocked up or taken out.

Here, the main body includes a first area corresponding to the stocking up of the food and a second area corresponding to the taking out of the food. Further, if it is detected that the food is located in the first area through the image, the processor 170 may detect the stocking up of the food located in the first area. If it is detected that the food is located in the second area through the image, the processor 170 may detect the taking out of the food located in the second area.

Also, if the food is located in one of the first area or the second area through the image captured by the camera 110, the processor 170 may extract an area about the food located in one of the first area or the second area. If an area about food is extracted, the processor 170 may control an output portion 120 to provide fourth feedback notifying detection of food.

Here, the first feedback may include at least one of auditory feedback including audio sound or a vice notifying the stocking up or the taking out of the food or visual feedback including an indicator corresponding to the stocking up or the taking out of the food.

Also, the processor 170 may obtain information about a storage location of food detected to be stocked up or taken out based on information about food stored in the storage chamber and the pantry stored in the memory 160 and the image captured by the camera.

Also, the processor 170 may provide the communication interface 130 to transmit the image captured by the camera to the external server for object recognition. Further, the processor 170 may obtain information about food included in the image captured by the camera 110 from the external server through the communication interface 130.

Also, if a user voice including the information about food is inputted through the microphone 140, the processor 170 may obtain information about food by performing voice recognition about the input user voice.

Also, the processor 170 may control a display 123 to display information about food that is stocked up or taken out and information about a storage location. Also, the processor 170 may control the communication interface 130 to transmit information about food that is stocked up or taken out and information about a storage location to a user terminal.

Also, the processor 170 may recognize a user who stocks up or takes out food. Further, the processor 170 may obtain consumption pattern information about the food of the recognized user based on the information about the food that is stocked up or taken out. Still further, the processor 170 may provide at least one of dietary guide information or food purchasing information based on the consumption pattern information about the food.

As above, the refrigerator 100 may provide various feedback in a process of stocking up or taking out food, so that the user may more specifically confirm information about food in the process of stocking up or taking out food and thus, more efficiently manage food.

FIGS. 2A and 2B are views illustrating a refrigerator when a door of the refrigerator is opened or closed according to an embodiment. It is shown in FIGS. 2A and 2B that the refrigerator 100 has a door 210, 220 on both sides of its upper part but the disclosure is not limited thereto, wherein the refrigerator 100 may be implemented in a French Door Type, a Side-by-side Type, or the like according to arrangements of the door 210, 220, the main body 230, or the like

As shown in FIG. 2A, the refrigerator 100 may include the door 210, 220 on both sides of its upper part. Further, the refrigerator 100 may include a display 123 on one or more doors among the door 210, 220 on both sides of its upper part. Here, onto the display 123, not only information about food stored in the refrigerator 100 but also various information (e.g. event information received from the outside, alarm information, recipe information) may be provided.

The refrigerator 100 may further include the main body 230 as shown in FIG. 2B. The main body 230 may include a storage chamber which is opened by an openable or closeable door 210, 220 and stores water, beverage, chilled food, or frozen food. Here, the storage chamber may include a plurality of receiving spaces and storage spaces.

The main body 230 may include an inner case (not shown) forming the plurality of receiving spaces and storage spaces, an outer case (not shown) forming an appearance of the refrigerator, and an insulator (not shown) maintaining a difference in temperatures between the inner case and the outer case. The insulator may prevent cool air inside the storage chamber from leaking into the outside and prevent external warmth from flowing into the inside of the storage chamber. The storage chamber may be comparted by a partition disposed inside the main body 230. The storage chamber may be divided into a freezing chamber disposed at a lower part and a refrigerating chamber disposed at an upper part of the refrigerator 100. However, an arrangement of the freezing chamber and the refrigerating chamber is not limited thereto and the arrangement may be made such that their positions are switched.

The door 210, 220 may rotate at an angle (e.g. 300° or less) defined by a hinge and may open and close part of a front surface of the storage chamber of the main body 230.

Here, the second door 220 among the plurality of doors 210, 220 may include the display 123 which may display a function and a setting of the refrigerator 100 on its surface and change the same by a user input (e.g. a touch or selection of a button). Besides, at least partial door among the plurality of doors 210, 220 may further include a dispenser providing water, ice, or sparkling water and/or a grippable handle, etc.

In particular, the main body 230 may further include a stocking up or taking out detection area for detecting the stocking up or taking out of food. That is, if the user places food at the stocking up or taking out detection area, the camera 110 may photograph the food placed at the stocking up or taking out detection area, and the processor 170 may detect the stocking up or taking out of food through the image captured by the camera 110. With respect to the above, the description is more specifically made with reference to FIGS. 3A to 3D.

As shown in FIG. 3A, the stocking up or taking out detection area 310 may be arranged at a partial area generated at a lower end area of the main body 230 when the door 210, 220 is opened. Here, the camera 110 may photograph the stocking up or taking out detection area 310 as shown in FIG. 3A.

In particular, the stocking up or taking out detection area 310 may include a first area (or stocking up area) 320 corresponding to the stocking up and a second area (or taking out area) 330 corresponding to the taking out. As an embodiment, as shown in FIG. 3B, the stocking up or taking out detection area 310 may include the first area 320 corresponding to the stocking up of a left area of the stocking up or taking out detection area 310 and may include the second area 330 corresponding to the taking out of a right area of the stocking up or taking out detection area 310. Here, the first area 320 corresponding to the stocking up may be provided with a first arrow directing toward the main body 230 of the refrigerator 100 through the LED 122 in the first area 320 corresponding to the stocking up and may be provided with a second arrow directing toward the outside of the refrigerator 100 through the LED 122 in the second area 330 corresponding to the taking out. As another embodiment, as shown in FIG. 3C, the stocking up or taking out detection area 310 may include a plurality of first areas 320-1, 320-2 corresponding to the stocking up and a plurality of second areas 330-1, 330-2 corresponding to the taking out. As another embodiment, as shown in FIG. 3D, the refrigerator 100 may include a plurality of stocking up or taking out detection areas 310-1, 310-2, 310-3 corresponding to a stocking up or taking out location of food. Here, each of the plurality of stocking up or taking out detection areas 310-1, 310-2, 310-3 may include a first area and a second area. For example, if food is stocked up to a left pantry positioned at the left door 210 or food stored in the left pantry is taken out, the user may place food to be stocked up or taken out at the first stocking up or taking out detection area 310-1.

The refrigerator 100 includes the stocking up or taking out detection area 310, so that the refrigerator 100 may more rapidly identify the user's intention for stocking up or taking out food and more rapidly provide feedback related to the stocking up or taking out.

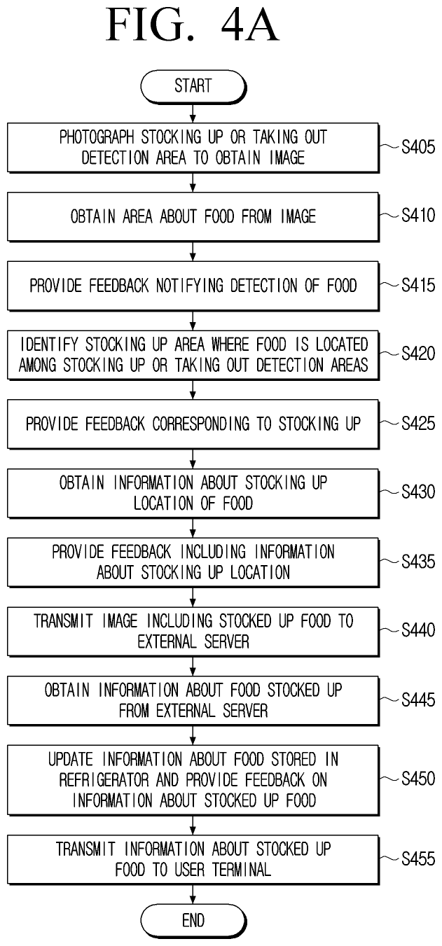

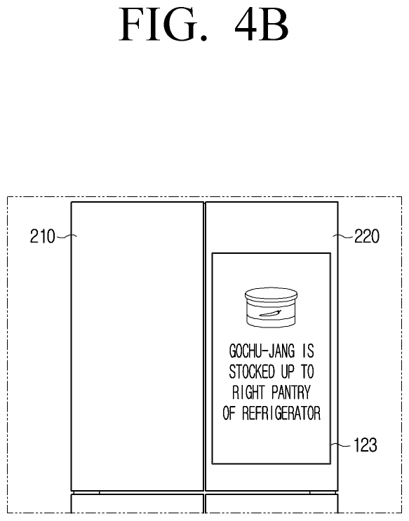

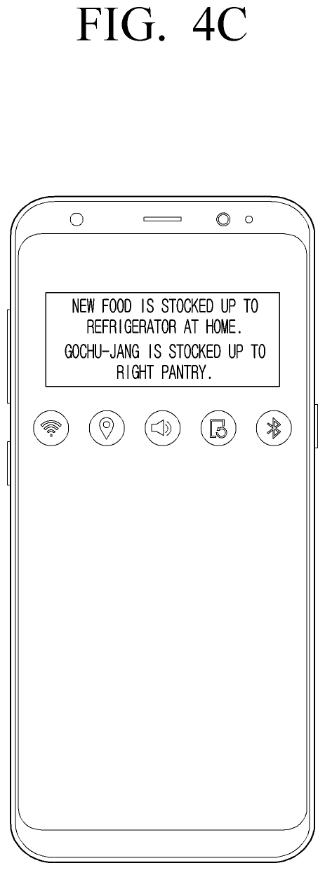

FIG. 4A is a flow chart illustrating a method providing feedback when food is stocked up to a refrigerator according to an embodiment.

The refrigerator 100 may photograph a stocking up or taking out detection area to obtain an image (S405). Here, the refrigerator 100, when detecting that the door 210, 220 of the refrigerator 100 is opened or a user approaches the refrigerator 100, may photograph the stocking up or taking out detection area 310 to obtain an image.

The refrigerator 100 may obtain an area about food from the image (S410). Specifically, the refrigerator 100 may detect whether the area about food exists among the image where the stocking up or taking out detection area is photographed and obtain the area about food depending on a detection result.

The refrigerator 100 may provide feedback notifying detection of food (S415). Here, the refrigerator 100 may provide feedback via specific sound (e.g. “ding-dong”, “beep sound”) of the speaker 121 but it is merely an example, wherein the refrigerator may provide an auditory message including audio sound “recognized” or a visual message through a flash of the LED 122 positioned at the stocking up or taking out detection area 310.

The refrigerator 100 may identify a stocking up area 320 where food is positioned among the stocking up or taking out detection areas 310 (S420). That is, if food is placed at the stocking up area 320 corresponding to the stocking up among the stocking up or taking out detection areas, the refrigerator 100 may identify the stocking up area 320 where food is positioned through image analysis and recognize that the user stocks up food. For examples, the refrigerator 100 may recognize an indicator (e.g. an arrow directing toward the main body 230) indicated on the stocking up area 320 to identify the stocking up area.

The refrigerator 100 may provide feedback corresponding to the stocking up (S425). As an example, the refrigerator 100 may provide auditory feedback “Stock up” together with specific sound through the speaker 121 and may provide visual feedback in which an indicator (e.g. an arrow directing toward the main body 230 of the refrigerator 100) blinks through the LED 122 positioned at the stocking up or taking out detection area 310.

Here, the refrigerator 100 may obtain a user voice notifying the stocking up of food through the microphone 140 besides an action in which the user places food at the stocking up or taking out detection area 310. For example, the refrigerator 100 may obtain a user voice “Stock up Gochu-jang”. Further, the refrigerator 100 may recognize the obtained user voice to obtain text information and may obtain information about food together with information about the stocking up based on the obtained text information.

The refrigerator 100 may obtain information about a stocking up location of food (S430). Specifically, the refrigerator 100 may analyze the image captured by the camera 110 to obtain information about the stocking up location where the user stores food in the refrigerator 100. For example, if the user stocks up food to the right pantry, the refrigerator 100 may analyze the image captured through the camera 110 to identify the right pantry in the refrigerator 100 as a stocking up location. Otherwise, as shown in FIG. 3D, the refrigerator 100 may identify a location corresponding to the stocking up or taking out detection area where food is positioned among a plurality of stocking up or taking out detection areas as a stocking up location to obtain information about a stocking up location. For example, if the user places food at the stocking up or taking out detection area 310-3 corresponding to the right pantry, the refrigerator 100 may analyze the image photographing the stocking up or taking out detection area to identify the right pantry in the refrigerator 100 as a stocking up location.

The refrigerator 100 may provide feedback including information about the stocking up location (S435). As an example, the refrigerator 100 may provide auditory feedback “Stocked up to the right pantry” together with specific sound through the speaker 121 and provide visual feedback in which the LED 122 positioned at the right pantry blinks.

The refrigerator 100 may transmit the image including stocked up food to the external server (S440). Here, the image including the stocked up food may be an image where food is positioned at the stocking up or taking out detection area 310 but it is merely an example, wherein it may be an area about food among the image obtained in the step S410. Alternatively, the external server may include a machine learning model (e.g. a neural network model for object recognition) trained to recognize an object (in particular, food) included in the image and may be a server storing various information about food.

The refrigerator 100 may obtain information about a stocked up food from the external server (S445). That is, the refrigerator 100 may obtain information about food obtained through a neural network model included in the external server (e.g. a type of food, a manufacturer manufacturing food, a capacity of food, recipe information using food, etc.).

Meanwhile, it is described in the aforementioned example that the refrigerator 100 obtains information about food through the neural network model included in the external server but it is merely an example, wherein the refrigerator 100 may store the neural network model which may obtain information about food and obtain information about food through the stored neural network model. Otherwise, as previously described, it is obvious that information about food may be obtained through a user voice inputted when stocking up.

The refrigerator 100 may update information about food stored in the refrigerator 100 and provide feedback on the information about the stocked up food (S450). Specifically, the refrigerator 100 may add the information about the stocked up food to a database of the memory 160 and update information about food stored in the refrigerator 100. Further, the refrigerator 100 may display information about stocked up food and information about a stocking up location of food through the display 123. Specifically, as shown in FIG. 4B, the refrigerator 100 may display a message ‘Gochu-jang is stocked up to the right pantry of the refrigerator” together with an image of Gochu-jang through the display 123. Otherwise, the refrigerator 100 may provide auditory feedback “Gochu-jang is stocked up to the right pantry of the refrigerator” through the speaker 121. Here, the refrigerator 100 may correct information about stocked up food through a touch action of the user on the display 123.

The refrigerator 100 may transmit information about the stocked up food to the user terminal (S455). Here, the refrigerator 100 may directly transmit information about stocked up food to a user terminal but it is merely an example, wherein the refrigerator 100 may transmit information about stocked up food to the external server which may be accessed by the user terminal. If the information about the stocked up food is received by the user terminal, the user terminal may provide information about stocking up of food and information about stocked up food. For example, as shown in FIG. 4C, the user terminal may display a text message “New food is stocked up to the refrigerator at home. Gochu-jang is stocked up to the right pantry.” on an upper end of the display as a feed message.

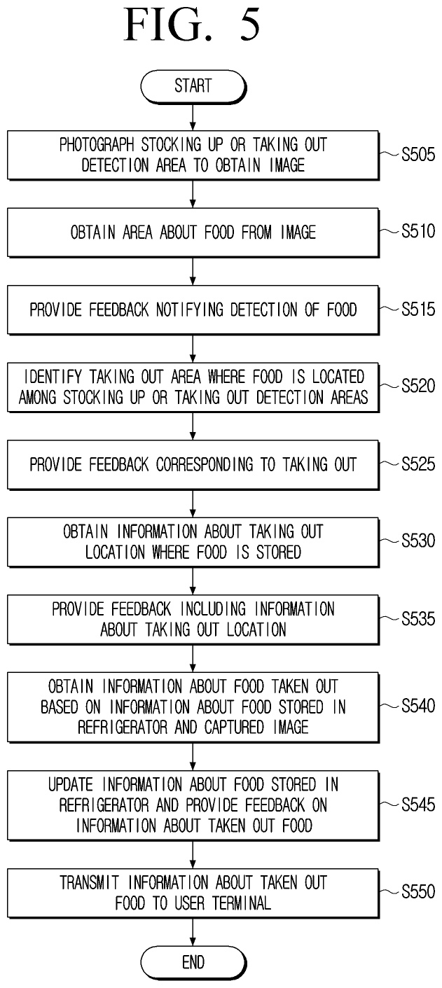

FIG. 5 is a flow chart illustrating a method providing feedback when food is taken out from a refrigerator according to an embodiment.

The refrigerator 100 may photograph a stocking up or taking out detection area to obtain an image (S505). Here, the refrigerator 100, when detecting that the door 210, 220 of the refrigerator 100 is opened or a user approaches the refrigerator 100, may photograph the stocking up or taking out detection area 310 to obtain an image.

The refrigerator 100 may obtain an area about food from the image (S510). Specifically, the refrigerator 100 may detect whether the area about food exists among the image where the stocking up or taking out detection area is photographed and may obtain the area about food depending on a detection result.

The refrigerator 100 may provide feedback notifying detection of food (S515). Here, the refrigerator 100 may provide feedback via specific sound (e.g. “ding-dong”, “beep sound”) of the speaker 121 but it is merely an example, wherein it may provide an auditory message including audio sound “recognized” or a visual message through a flash of the LED 122 positioned at the stocking up or taking out detection area 310.

The refrigerator 100 may identify a taking out area 330 where food is positioned among the stocking up or taking out detection areas 310 (S520). That is, if food is placed at the taking out area 330 corresponding to the taking out among the stocking up or taking out detection areas, the refrigerator 100 may identify the taking out area 330 where food is positioned through image analysis and may recognize that the user takes out food. For examples, the refrigerator 100 may recognize an indicator (e.g. an arrow directing toward the outside of the refrigerator 100) indicated at the taking out area 320 to identify the taking out area.

The refrigerator 100 may provide feedback corresponding to the taking out (S525). As an example, the refrigerator 100 may provide auditory feedback “Take out” together with specific sound through the speaker 121 and may provide visual feedback in which an indicator (e.g. an arrow directing toward the outside of the refrigerator 100) blinks through the LED 122 positioned at the stocking up or taking out detection area 310.

Here, the refrigerator 100 may obtain a user voice notifying the taking out of food through the microphone 140 besides an action in which the user places food at the stocking up or taking out detection area 310. For example, the refrigerator 100 may obtain a user voice “Take out Gochu-jang”.

The refrigerator 100 may obtain information about a taking out location of food (S530). Specifically, the refrigerator 100 may analyze the image captured by the camera 110 to obtain information about the taking out location where food is stored in the refrigerator 100. For example, if the user takes out food stored in a top shelf of the storage chamber, the refrigerator 100 may analyze the image captured by the camera 110 and identify the top shelf of the storage chamber in the refrigerator 100 as a taking out location. Otherwise, as shown in FIG. 3D, if food is positioned at the stocking up or taking out detection area corresponding to the storage chamber among a plurality of stocking up or taking out detection areas, the refrigerator 100 may identify the storage chamber as a taking out location and obtain information about the taking out location.

The refrigerator 100 may provide feedback including information about a taking out location (S535). As an example, the refrigerator 100 may provide auditory feedback “Food stored at the top shelf of the storage chamber is taken out” together with specific sound through the speaker 121 and provide visual feedback in which the LED 122 positioned at the top shelf of the storage chamber blinks.

The refrigerator 100 may obtain information about food that is taken out based on information about food stored in the refrigerator 100 and the captured image (S540). Specifically, the refrigerator 100 may compare a previously stored image of the inside of the refrigerator 100 with an image of the inside of the refrigerator 100 captured after taking out and obtain information about the taken out food. For example, the refrigerator 100 may compare a previously stored image of the top shelf of the storage chamber with an image of the top shelf of the storage chamber captured after taking out and identify that Gochu-jang stored in the top shelf of the storage chamber is taken out.

Alternatively, the refrigerator 100 may transmit the image about the taken out food to the external server and obtain information about the taken out food from the external server as shown in the steps S440 and S445.

The refrigerator 100 may update information about food stored in the refrigerator 100 and provide feedback on the information about the taken out food (S545). Specifically, the refrigerator 100 may delete the information about the taken out food from a database of the memory 160 to update information about food stored in the refrigerator 100. Further, the refrigerator 100 may display information about taken out food and information about a taken out location of food through the display 123. Otherwise, the refrigerator 100 may provide auditory feedback “Gochu-jang is taken out from the top shelf of the storage chamber” through the speaker 121. Here, the refrigerator 100 may correct information about taken out food through a touch action of the user on the display 123.

The refrigerator 100 may transmit information about the taken out food to the user terminal (S550). Here, the refrigerator 100 may directly transmit information about taken out food to a user terminal but it is merely an example, wherein the refrigerator 100 may transmit information about taken out food to the external server which may be accessed by the user terminal. If information about taken out food is received by the user terminal, the user terminal may provide information about taking out of food and information about taken out food. For example, the user terminal may display a text message “Food is taken out from the refrigerator at home. Gochu-jang of the top shelf of the storage chamber is taken out.” on the upper end of the display as a feed message.

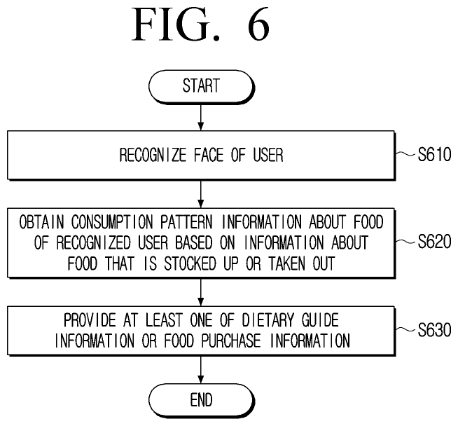

FIG. 6 is a flow chart illustrating a method of obtaining a consumption pattern of a user according to stocking up or taking out of food to provide various services according to an embodiment.

The refrigerator 100 may recognize a user (S610). That is, the refrigerator 100 may photograph a face of the user who stocks up or takes out food through the camera 110 to recognize the user. Alternatively, the refrigerator 100 may analyze a user voice inputted through the microphone 140 included in the refrigerator to recognize the user. Besides, the refrigerator 100 may recognize user information through biometric information such as an iris or a fingerprint of the user.

The refrigerator 100 may obtain consumption pattern information about food of the recognized user based on information about food that is stocked up or taken out (S620). For example, the refrigerator 100 may obtain preferred food of the recognized user, the number of food purchase of the recognized user, an amount of food consumption of the recognized user, or the like based on information about food that is stocked up or taken out.

The refrigerator 100 may provide at least one of dietary guide information or food purchasing information based on the obtained consumption pattern information (S630). For example, if the number of soda drink intake of a first user exceeds a threshold number, the refrigerator 100 may provide dietary guide information about soda drink. As another example, if Gochu-jang is not stocked up during a threshold time (e.g. 3 days) after Gochu-jang is taken out, the refrigerator 100 may provide information notifying a purchase recommendation and a purchase method of Gochu-jang (e.g. a web page for purchasing Gochu-jang or a Gochu-jang advertisement image).

As above, various services may be provided by recognizing a user, analyzing information in which the recognized user stocks up or takes out food, and obtaining consumption pattern information.

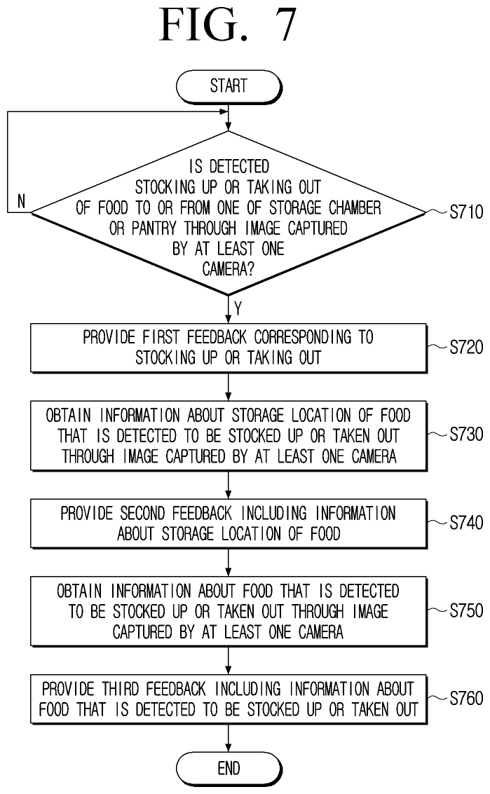

FIG. 7 is a flow chart illustrating a method of controlling a refrigerator providing various feedback according to stocking up or taking out of food according to an embodiment.

The refrigerator 100 determines whether stocking up or taking out of food to or from one of the storage chamber or the pantry is detected through the image captured by at least one camera (S710). In particular, the main body of the refrigerator 100 includes a first area corresponding to the stocking up of the food and a second area corresponding to the taking out of the food. Also, the main body includes a plurality of first areas and a plurality of second areas corresponding to each of the storage and the pantry.

Specifically, if it is detected that the food is located in the first area through the image, the refrigerator 100 may determine the stocking up of the food located in the first area. If it is detected that the food is located in the second area through the image, the refrigerator 100 may detect the taking out of the food located in the second area.

Here, if the food is located in one of the first area or the second area through the image captured by the camera 110, the refrigerator 100 may extract an area about the food located in one of the first area or the second area. If the area about food is extracted, the refrigerator 100 may provide feedback notifying detection of food.

If stocking up or taking out of food is detected (S710-Y), the refrigerator 100 provides first feedback corresponding to the stocking up or taking out (S720). Here, the first feedback may include at least one of auditory feedback including audio sound notifying the stocking up or the taking out of the food or visual feedback including an indicator (e.g. an arrow) corresponding to the stocking up or the taking out of the food.

The refrigerator 100 obtains information about a storage location of food that is detected to be stocked up or taken out though the image captured by the camera 110 (S730). Here, the refrigerator 100 may obtain information about a storage location of food detected to be stocked up or taken out based on information about food stored in the storage chamber and the pantry stored and the image captured by the camera 110.

The refrigerator 100 provides second feedback including the information about the storage location of the food (S740). Here, the second feedback may also include at least one of auditory feedback including information about the storage location of food or visual feedback through the LED included in the storage location of food.

The refrigerator 100 obtains information about food that is detected to be stocked up or taken out through the image captured by the camera (S750). Specifically, the refrigerator 100 may transmit the image captured by the camera 110 to the external server for object recognition and obtain information about food included in the image captured by the camera from the external server through the communication interface 130. Otherwise, if a user voice including the information about food is inputted through the microphone 140, the refrigerator 100 may perform voice recognition about the input user voice to obtain information about food.

The refrigerator 100 provides third feedback including the information about the food that is detected to be stocked up or taken out (S760). Specifically, the refrigerator 100 may display information about food that is stocked up or taken out and information about a storage location on the display 123 located at the door. Also, the refrigerator 100 may transmit information about food that is stocked up or taken out and information about a storage location to a user terminal to provide feedback to the user terminal.

Meanwhile, the refrigerator 100 may recognize a user who stocks up or takes out food. Further, the refrigerator 100 may obtain consumption pattern information about the food of the recognized user based on the information about the food that is stocked up or taken out. Still further, the refrigerator 100 may provide at least one of dietary guide information or food purchasing information based on the consumption pattern information about the food.

Meanwhile, according to an embodiment of the disclosure, the processor 170 may control to process input data according to a predefined operation rule or an AI model stored in the memory 160. The predefined operation rule or the AI model is constructed by learning.

Here, the construction by learning means that the predefined operation rule or the AI model having a desired characteristic is constructed by applying a learning algorithm to various learning data. This learning may be performed in a device itself where the AI according to the disclosure is performed and may be also performed through a separate server/system.

The AI model (e.g. first and second object detection networks) may be configured of a plurality of neural network layers. At least one layer has at least one weight value and performs an operation of the layer through an operation result of the previous layer and at least one defined operation. An example of the neural network is a Convolutional Neural Network (CNN), a Deep Neural Network (DNN), a Recurrent Neural Network (RNN), a Restricted Boltzmann Machine (RBM), a Deep Belief Network (DBN), a Bidirectional Recurrent Deep Neural Network (BRDNN), a Deep Q-Network, or a Transformer, wherein the neural network of the disclosure is not limited to the aforementioned example, excluding a case that the neural network is designated as the aforementioned example.

The learning algorithm is a method by which a given target device is trained by using a plurality of learning data such that the given target device may make or predict a decision by itself. An example of the learning algorithm is supervised learning, unsupervised learning, semi-supervised learning, or reinforcement learning, wherein the learning algorithm of the disclosure is not limited to the aforementioned examples, excluding a case that the learning algorithm is designated as the aforementioned examples.

Meanwhile, a method according to various embodiments of the disclosure may be provided to be included in a computer program product. The computer program product may be traded between a seller and a buyer as goods. The computer program product may be distributed in a form of the machine-readable storage medium (e.g. compact disc read only memory (CD-ROM)) or on-line distributed (e.g. downloaded or uploaded) via an application store (e.g. play store™) or directly between two user devices (e.g. smart phones). In the case of the on-line distribution, at least part of the computer program product (e.g. a downloadable app) may be stored at least temporarily or may be generated temporarily in the machine-readable storage medium such as memory of a server of a manufacturer, a server of an application store, or a relay server.

The method according to various examples of the disclosure may be implemented as software including instructions stored in the machine-readable storage media, which can be read by the machine (e.g. a computer). The machine refers to a device which calls instructions stored in the storage medium and is operable according to the called instructions, wherein it may include an electronic device (e.g. a refrigerator) according to the disclosed embodiments.

Meanwhile, a machine readable storage medium may be provided in a form of a non-transitory storage medium. Here, the term ‘non-transitory storage medium’ merely means that the storage medium is a tangible device and does not include a signal (e.g. an electromagnetic wave), wherein the term does not distinguish a case where data is stored semi-permanently in the storage medium from a case where data is stored temporarily in the storage medium. For example, the ‘non-transitory storage medium’ may include a buffer where data is temporarily stored.

If the instructions are executed by a processor, the processor may perform a function corresponding to the instructions directly or by using other components under control of the processor. The instructions may include a code generated or executed by a compiler or an interpreter.

As above, preferable examples of the present disclosure are shown and described. However, it is obvious that the disclosure is not limited to the aforementioned specific examples, and various modifications may be implemented by those skilled in the art without deviating from the gist of the disclosure claimed in the scope of claims, wherein these modifications should not be independently understood from the technical spirit or prospect of the disclosure.

What is claimed is:

1. A refrigerator comprising:
a main body including a storage chamber;
a door coupleable to the main body so that while the door and the main body are coupled to each other the door is rotatable to open and close the storage chamber, the door including a pantry;
a camera;
an output portion;
a memory to store at least one instruction; and
a processor coupleable to the memory and configured to execute the at least one instruction to:
based on introducing of an item to or withdrawing of the item from one of the storage chamber or the pantry being detected through the image that is captured by the camera, control the output portion to provide first feedback corresponding to the item being introduced or withdrawn;
obtain information about a storage location of the item that is detected to be introduced or withdrawn through the image captured by the camera;
control the output portion to provide second feedback including the information about the storage location of the item;
obtain information about the item that is detected to be introduced or withdrawn through the image captured by the camera; and
control the output portion to provide third feedback including the information about the item that is detected to be introduced or withdrawn.

2. The refrigerator of claim 1, wherein the main body includes a first area corresponding to the introducing of the item and a second area corresponding to the withdrawing of the item, and
wherein the processor is configured to:
based on detecting that the item is located in the first area through the image, detect the introducing of the item located in the first area; and
based on detecting that the item is located in the second area through the image, detect the withdrawing of the item located in the second area.

3. The refrigerator of claim 2, wherein the processor is configured to:
based on the item being located in one of the first area or the second area through the image captured by the camera, extract an area about the item located in one of the first area or the second area; and
based on an area about the item being extracted, control the output portion to provide fourth feedback notifying detection of the item.

4. The refrigerator of claim 2, wherein the main body includes a plurality of first areas and a plurality of second areas corresponding to each of the storage chamber and the pantry.

5. The refrigerator of claim 1, wherein the output portion includes a speaker providing auditory feedback and a lighting providing visual feedback, and
wherein the first feedback includes:
at least one of auditory feedback including audio sound notifying the introducing or the withdrawing of the item or visual feedback including an indicator corresponding to the introducing or the withdrawing of the item.

6. The refrigerator of claim 1, wherein the memory stores the information about the item stored in the storage chamber and the pantry, and
wherein the processor is configured to:
obtain the information about the storage location of the item that is detected to be introduced or withdrawn based on the information about the item stored in the storage chamber and the pantry stored in the memory and the image captured by the camera.

7. The refrigerator of claim 1, further comprising:
a communication interface performing communication with an external server,
wherein the processor is configured to:
control the communication interface to transmit the image captured by the camera to the external server for object recognition; and
obtain the information about the item included in the image captured by the camera from the external server through the communication interface.

8. The refrigerator of claim 1, further comprising:
a microphone,
wherein the processor is configured to:
based on a user voice including the information about the item being inputted through the microphone, perform voice recognition about the input user voice to obtain the information about the item.

9. The refrigerator of claim 1, wherein the refrigerator further includes:
a communication interface performing communication with an external server,
wherein the output portion includes a display located at the door, and
wherein the processor is configured to:
control the display to display the information about the item that is introduced or withdrawn and the information about the storage location; and
control the communication interface to transmit the information about the item that is introduced or withdrawn and the information about the storage location to a user terminal.

10. The refrigerator of claim 1, wherein the processor is configured to:
recognize a user who introduces or withdraws the item;
obtain consumption pattern information about the item of the recognized user based on the information about the item that is introduced or withdrawn; and
provide at least one of dietary guide information or item purchasing information based on the consumption pattern information about the item.

11. A method of controlling a refrigerator including a main body including a storage chamber, a door rotatably coupled to the main body to open and close the storage chamber and including a pantry, and a camera, comprising:
based on introducing or withdrawing item to or from one of the storage chamber or the pantry being detected through an image captured by the camera, providing first feedback corresponding to the introducing or the withdrawing, the camera being located in at least one of the main body or the door to capture the image which is that of at least one of the storage chamber or the pantry;
obtaining information about a storage location of the item that is detected to be introduced or withdrawn through the image captured by the camera;
providing second feedback including the information about the storage location of the item;
obtaining information about the item that is detected to be introduced or withdrawn through the image captured by the camera; and
providing third feedback including the information about the item that is detected to be introduced or withdrawn.

12. The method of claim 11, wherein the main body includes a first area corresponding to the introducing of the item and a second area corresponding to the withdrawing of the item, and
wherein the method of controlling comprises:
based on it being detected that the item is located in the first area through the image, detecting the introducing of the item located in the first area and based on it being detected that the item is located in the second area through the image, detecting the withdrawing of the item located in the second area.

13. The method of claim 12, wherein the method of controlling comprises:
based on the item being located in one of the first area or the second area through the image captured by the camera, extracting an area about the item located in one of the first area or the second area; and
based on the area about the item being extracted, providing fourth feedback notifying detection of the item.

14. The method of claim 12, wherein the main body includes a plurality of first areas and a plurality of second areas corresponding to each of the storage chamber and the pantry.

15. The method of claim 11, wherein the first feedback includes:
at least one of auditory feedback including audio sound notifying the introducing or the withdrawing of the item or visual feedback including an indicator corresponding to the introducing or the withdrawing of the item.

16. The method of claim 11, wherein the refrigerator stores the information about the item stored in the storage chamber and the pantry, and
wherein the obtaining information about a storage location of the item comprises:
obtaining the information about the storage location of the item that is detected to be introduced or withdrawn based on the information about the item stored in the storage chamber and the pantry stored in the refrigerator and the image captured by the camera.

17. The method of claim 11, wherein the method of controlling comprises:
transmitting the image captured by the camera to the external server for object recognition; and
obtaining the information about the item included in the image captured by the camera from the external server.

18. The method of claim 11, wherein the obtaining information about the item comprises:
based on a user voice including the information about the item being inputted through the microphone, performing voice recognition about the input user voice to obtain the information about the item.

19. The method of claim 11, wherein the providing third feedback comprises displaying the information about the item that is introduced or withdrawn and the information about the storage location, and
wherein the method of controlling comprises:
transmitting the information about the item that is introduced or withdrawn and the information about the storage location to a user terminal.

20. A computer readable recording medium storing a program for executing a method of controlling a refrigerator including a main body including a storage chamber, a door coupleable to the main body so that while the door and the main body are coupled to each other the door is rotatable to open and close the storage chamber and including a pantry, and a camera located in at least one of the main body or the door to capture an image at least one of the storage chamber or the pantry,
the control method includes,
based on introducing of an item to or withdrawing of the item from one of the storage chamber or the pantry being detected through the image captured by the camera, providing first feedback corresponding to the item being introduced or withdrawn,
obtaining information about a storage location of the item that is detected to be introduced or withdrawn through the image captured by the camera,
providing second feedback including the information about the storage location of the item,
obtaining information about the food that is detected to be introduced or withdrawn through the image captured by the camera, and
providing third feedback including the information about the item that is detected to be introduced or withdrawn.
